(19) United States
(12) Patent Application Publication
(10) Pub. No.: US 2016/0023439 A1
(43) Pub. Date: Jan. 28, 2016

(54) METHOD FOR JOINING HIGH TEMPERATURE MATERIALS AND ARTICLES MADE THEREWITH

(71) Applicant: GENERAL ELECTRIC COMPANY, SCHENECTADY, NY (US)

(72) Inventors: Qi Zhao, Niskayuna, NY (US); Steve John Buresh, Latham, NY (US); Voram Supatarawanich Dheeradhada, Latham, NY (US); Judson Sloan Marte, Troy, NY (US); Wanming Zhang, Clifton Park, NY (US)

(21) Appl. No.: 14/337,850

(22) Filed: Jul. 22, 2014

(51) Int. Cl. B32B 15/01; B23K 31/02; C22C 14/00; C22F 1/18; C22C 19/03; B23K 20/02; C22F 1/10

(52) U.S. Cl. CPC B32B 15/017; B23K 20/023; B23K 31/02; C22F 1/10; C22F 1/183; C22C 19/03; C22C 14/00; B32B 2250/03; B32B 2603/00

(57) ABSTRACT

Methods for joining dissimilar high-temperature alloys are provided, along with articles, such as turbine airfoils, formed by the method. The method comprises interposing a barrier material between a first segment and a second segment to form a segment assembly. The first segment comprises a titanium aluminide material, and the second segment comprises a nickel alloy. The barrier material comprises a primary constituent element present in the barrier material at a concentration of at least about 30 weight percent of the barrier material, and the primary constituent element is a transition metal element of Group 1B, Group 4B (excluding titanium and zirconium), Group 5B, Group 6B, Group 7B, or Group 8B (excluding nickel). The segment assembly is bonded in the solid state at a combination of temperature, pressure, and time effective to produce a metallurgical joint between the first and second segments, thereby forming an intermediate article; and the intermediate article is heat treated to form a bonded article.

### BACKGROUND

This disclosure generally relates to methods for joining titanium-bearing alloys to nickel-based materials. In particular, this disclosure relates to solid-state bonding of titanium aluminide alloys to nickel-based superalloys, and to articles made using such methods.

The selection of a particular alloy for use in a given machine component design, such as a gas turbine component, is accomplished based on the critical design requirements for a number of material properties, including strength, toughness, environmental resistance, weight, cost, and others. When one alloy is used to construct the entire component, compromises must be made in the performance of the component because no single alloy possesses ideal values for the long list of properties required for the application, and because conditions of temperature, stress, impingement of foreign matter, and other factors are not uniform over the entire component surface.

It would be advantageous if the performance of machine components could be improved to better withstand the aggressive conditions present in localized areas. However, it would not be desirable if improvements to one property were effected at the expense of other design critical requirements of the component. Therefore, it would be beneficial if turbine components and other high-temperature machine components could be improved in a manner that would allow, for example, enhanced performance in regions susceptible to aggressive stress and temperature conditions, without significantly detracting from the overall performance of the component.

One way to achieve the result described above is to dispose segments at certain locations of the component, where the segments are made of materials with properties optimized for conditions local to their respective locations, and join the segments together to form and overall component having strategically distributed, location-specific properties. This strategy, however, assumes the existence of joining processes that are suitable for bonding the segments together. While conventional processes such as welding and brazing are adequate for certain material combinations under certain circumstances, there remain considerable limitations on the types of materials that may be joined and under what conditions the joint would provide suitable properties.

Therefore, a need remains for joining processes suitable for bonding advanced high temperature materials to form composite structures having properties adequate for use in demanding applications such as gas turbine machinery. A need also persists for strategically designed components that can achieve a required distribution of properties through the use of locally optimized material compositions and structures.

### BRIEF DESCRIPTION

Embodiments of the present invention are provided to meet this and other needs. One embodiment is a method. The method comprises interposing a barrier material between a first segment and a second segment to form a segment assembly. The first segment comprises a titanium aluminide material, and the second segment comprises a nickel alloy. The barrier material comprises a primary constituent element present in the barrier material at a concentration of at least about 30 weight percent of the barrier material, and the primary constituent element is a transition metal element of Group 1B, Group 4B (excluding titanium and zirconium), Group 5B, Group 6B, Group 7B, or Group 8B (excluding nickel). The segment assembly is bonded in the solid state at a combination of temperature, pressure, and time effective to produce a metallurgical joint between the first and second segments, thereby forming an intermediate article; and the intermediate article is heat treated to form a bonded article.

Another embodiment is an article comprising a first portion bonded to a second portion via transition zone. The first portion comprises a titanium aluminide material, the second portion comprises a nickel alloy. The barrier material comprises a primary constituent element present at a concentration of at least about 30 weight percent of the barrier material; the primary constituent element is a transition metal element of Group 1B, Group 4B (excluding titanium and zirconium), Group 5B, Group 6B, Group 7B, or Group 8B (excluding nickel). The transition zone comprises a concentration of the primary constituent element that is higher than a concentration of the constituent element in the first portion and the second portion.

### DRAWINGS

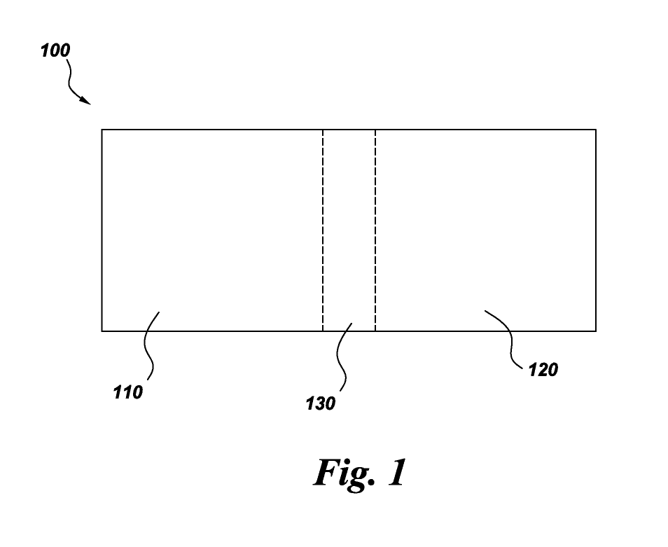

These and other features, aspects, and advantages of the present invention will become better understood when the following detailed description is read with reference to the accompanying drawing in which like characters represent like parts, wherein FIG. 1 is a schematic cross-sectional view of an illustrative embodiment of the present invention.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

Embodiments of the present invention include a method for solid-state metallurgical bonding of disparate high-temperature materials. In particular, the method provides for solid-state diffusion bonding of titanium aluminide materials to nickel-based materials, such as superalloys; such bonding enables the fabrication of components comprising both of these attractive materials. Embodiments of the present invention also include components made from bonded segments of titanium aluminide and nickel-based superalloy. Embodiments of the present invention include a method for diffusion bonding segments of dissimilar materials.

Diffusion bonding is a joining process in which segments to be joined are brought into contact at elevated levels of temperature and pressure, for sufficient time to effect a solid-state mass transfer via diffusion between segments, thereby forming a metallurgical bond between the segments. The process, though somewhat expensive compared to welding and brazing, is often advantageous where such liquid-phase joining techniques are difficult or impossible to successfully apply. In some alloy systems, such as certain nickel-base superalloys and titanium aluminides, welding and brazing are often difficult to employ successfully due to formation of deleterious phases and/or cracks in the heat affected zone, or due to reaction with filler material. In particular, when attempting to join dissimilar materials, complications may arise where the two materials have significantly different reactions to filler materials and/or thermal excursions during joining. Diffusion bonding, a solid-state joining process is therefore an attractive process for joining dissimilar materials that present difficulties for conventional liquid-phase processes.

In embodiments of the present invention, a first segment includes a titanium aluminide material. A “titanium aluminide material” for the purposes of this description is any of the class of materials known in the art as titanium aluminide alloys, that is, alloys that are based on an intermetallic compound that includes titanium and aluminum, such as TiAl or Ti₃Al. In contrast, conventional titanium alloys, such as Ti-6% Aluminum-4% Vanadium (known as “Ti 6-4” in the art), are based on various allotropic phases of titanium, such as hexagonal-close-packed alpha phase and body-centered-cubic beta phase. Titanium aluminide materials, such as those materials based on gamma titanium aluminide (TiAl), offer an attractive potential alternative to nickel-based superalloys in some applications due to their excellent high temperature mechanical and environmental resistance properties, combined with comparatively low density. Besides titanium and aluminum, the titanium aluminide material of the first segment may further include one or more additional elements commonly used in titanium aluminide-based alloys; examples of such elements include, without limitation, niobium, chromium, tungsten, iron, vanadium, silicon, carbon and boron. Possible phases present in the titanium aluminide material of the first segment include, without limitation, gamma titanium aluminide, borides, carbides, alpha (hexagonal close-packed structure) titanium, beta (body-centered cubic) titanium, and alpha-two (nominal composition Ti₃Al) phase.

A second segment comprises a nickel alloy, meaning that nickel is present in the highest weight fraction of all elements present in the alloy. In some embodiments, the alloy is of the so-called “superalloy” class. Such alloys generally include various precipitation-strengthened nickel alloys employing intermetallic precipitate phases such as gamma prime (Ni₃Al) dispersed in a face-centered cubic (“gamma” or austenite) matrix. Notable but non-limiting examples of such alloys include nickel-based superalloys such as GTD-111® (General Electric Co.), GTD-444® (General Electric Co.), IN-738, René™ N4 (General Electric Co.), René198 N5 (General Electric Co.), René™ 108 (General Electric Co.) and René™ N500 (General Electric Co.). Nickel-based superalloys have been employed extensively in high-temperature, high-stress applications, such as turbo-machinery components, due to their excellent high-temperature mechanical properties. In some embodiments, the superalloy of the second segment is in the form of a single crystal, while in other embodiments the alloy is polycrystalline, such as, for instance, a directionally solidified material having a plurality of columnar grains having substantially the same orientation. Directionally solidified and single crystalline materials offer enhanced resistance to creep at elevated temperatures.

Typically, when a nickel alloy and a titanium aluminide article are diffusion bonded using standard practices known in the art, the resulting bond is not acceptable for high-temperature applications due to the formation of deleterious phases and structures in the region of the bonding. For example, diffusion of aluminum and titanium from the aluminide into the nickel alloy during heating and bonding may result in the formation of a substantial amount of comparatively low-melting-point material during processing, such as for example, a eutectic phase, rich in nickel, titanium, and aluminum. Formation of such material may result in undesirable melting during the bonding process. The phases forming in the bond region may also be quite brittle compared to the base metals, and if sufficient volume fraction of such brittle phase is formed, such as where a substantially continuous region running along the length (or a substantial length) of the bond line is formed, or if the brittle phase forms in a network or other substantially continuous morphology, the mechanical properties of the resulting bonded article may be quite inferior to that of the constituent base metals. Previous work in bonding nickel alloys to titanium aluminide has included alteration of the surface of the titanium aluminide by laser cladding with a nickel-bearing alloy. However, such cladding did not stop the formation of continuous layers of potentially undesirable nickel-titanium-aluminum-rich layers along the bond line in the bonded article.

Embodiments of the present invention employ a barrier material interposed between the first and second segments to hinder significant migration of titanium and aluminum by diffusion between segments. An effective barrier material, for the purposes of this description, is one that sufficiently hinders formation of liquid phase during processing, and/or hinders formation of persistent, deleterious phases and structures, such as a substantially continuous layer of an embrittling phase or structure, or a substantial quantity of low-melting-point material. As used herein, “persistent” means that the phase or structure is sufficiently robust to survive through processing in accordance with the techniques set forth herein and thus remain in the bonded article. In addition to being an effective barrier to diffusion of these elements, the barrier material may promote bonding by having at least some solubility in titanium aluminide and/or nickel alloys, and by having reaction kinetics with titanium aluminide and nickel alloys such that they themselves tend not to form deleterious layers or networks, and/or unduly high volume fractions of brittle intermetallic phases, such as Laves phase, topologically close-packed phases (such as the iron- and chromium-bearing sigma phase), or body-centered cubic B2-type phases such as nickel aluminide (NiAl) phase. In certain embodiments, the barrier material includes a primary constituent element that is present in the barrier material at a concentration of at least about 30 weight percent. This primary constituent element is generally a transition metal element of Periodic Table Groups 1B, 4B, 5B, 6B, 7B, or 8B, with the proviso that the following elements from these enumerated groups are excluded from being present as primary constituent elements due to their propensity at high concentrations to promote formation of low-melting-point or brittle material: titanium, zirconium, and nickel. In particular embodiments, the primary constituent element is niobium or tantalum. The niobium or tantalum is present in a concentration of at least 50 weight percent of the barrier material in some embodiments, and in certain embodiments is at least 75 weight percent of the barrier material, including particular embodiments in which the barrier material is substantially 100% niobium or tantalum.

It should be noted that the barrier material is not limited to having only one element present at concentrations greater than about 30 weight percent; other elements may be present at these concentrations. Moreover, the barrier material need not be free of nickel, zirconium, and/or titanium, but these elements are generally present, if at all, as minor constituents, meaning their respective concentrations are not more than about 20 weight percent. Further, in some embodiments, the barrier material further comprises additional elements, such as boron, carbon, zirconium, and other elements that may enhance the ability of the barrier material to diffuse into either or both of the segments, enhance the mechanical properties (such as creep strength) of the bond, or otherwise promote desirable performance. Finally, the barrier material, in some embodiments, comprises a plurality of sub-layers, each of which independently comprises one or more of the materials described above. For instance, in one embodiment, the barrier material comprises a first layer disposed proximate to the first segment, and a second layer disposed proximate to the second segment. The first layer material composition is selected to promote beneficial metallurgical bonding with the material of the first segment, and the second layer material is selected to promote beneficial metallurgical bonding with the material of the second segment. Factors leading to beneficial metallurgical bonding include, for instance, solubility and/or sufficiently rapid interdiffusion at typical processing temperatures, suppression of deleterious phase formation, and compatibility with other sub-layers within the barrier material.

In embodiments of the present invention, the barrier material is interposed between the first and second segments to form a segment assembly that comprises the first segment, second segment, and the interposed barrier material. Interposing the barrier material may be accomplished using any of a number of methods to dispose material. For example, in one embodiment, a layer of the barrier material is deposited on one or both of the segments. The deposition of the barrier material may be performed by sputter coating, evaporation, and other forms of physical vapor deposition known in the art; by chemical vapor deposition techniques; and/or by other coating techniques such as thermal spraying and electroplating. Alternatively, a foil or other freestanding mass of the barrier material, or a powder comprising the barrier material, may be disposed between the segments. The barrier material thickness selected in any given instance will depend in part on the time, temperature, and pressure selected to perform the bonding step. If the thickness of the barrier layer is too small in the face of conditions that promote relatively fast diffusion (high temperature, long time, and/or high pressure) then the barrier may not provide sufficient hindrance of titanium and/or aluminum diffusion. If the thickness is too large, again depending on the selected processing conditions, then achieving sufficient mass transfer to create a satisfactory metallurgical bond may be difficult. In one embodiment, the thickness of the barrier material is at least 0.5 micrometers; in some embodiments the thickness may be up to about 40 micrometers. One illustrative embodiment includes interposing a barrier layer having a thickness in the range from about 0.5 microns to about 10 micrometers.

The segment assembly is then bonded. The bonding step is accomplished using standard diffusion bonding concepts. The assembly is subjected to a pressure, such as greater than about 4 megapascals, which promotes intimate contact between the components of the segment assembly. In some embodiments, the pressure is in the range from about 4 megapascals to about 7 megapascals. The pressure may be applied by any number of convenient means, including unidirectional pressing or isostatic pressing. The assembly while under pressure is also heated to a temperature sufficiently high to achieve diffusion rates that allow bonding to occur within a practical time period. The heating typically is performed in an inert environment, such as a helium-bearing atmosphere, an argon-bearing atmosphere, or under vacuum, to avoid undue oxidation of the materials and/or formation of undesirable quantities of deleterious phases, such as alpha-2. The actual temperature selected depends in part on the materials being used for the various parts of the segment assembly and the time deemed practical; in some embodiments this temperature is at least about 900 degrees Celsius, and in certain embodiments the temperature is in a range from about 900 degrees Celsius to about 1100 degrees Celsius. The time selected is dependent upon the other parameters selected, but in some embodiments ranges from about 10 minutes to about 4 hours. Upon exposure to the diffusion bonding step, the segment assembly components are bonded together, forming an intermediate article.

The intermediate article is then heat-treated to form a bonded article, again typically in an inert environment such as under vacuum or in an atmosphere containing a noble gas. The heat treatment step can perform various functions. One of the functions of the heat treatment step is to further diffuse the barrier material into the first and second segments, which enhances bonding and develops a more homogeneous distribution of composition across the interfaces between the segments and barrier material. Another, related, function is to mitigate deleterious phases or structures that may have formed during the bonding step, such as continuous regions of low-melting-point or embrittling material. Generally, the heat-treating step includes heating to a temperature sufficiently high, such as above 900 degrees Celsius in some embodiments, to achieve this function in a practical time, but sufficiently low, such as up to about 1300 degrees Celsius in some embodiments and up to about 1200 degrees Celsius in certain embodiments, to avoid the incipient melting temperature for material in the intermediate article. The intermediate article is held at this temperature for a time selected to achieve a desired degree of interdiffusion between the barrier material and the segments; in some embodiments this time is up to about 50 hours, and in particular embodiments is up to about 6 hours.

Another function of heat treating, in some embodiments, is to develop desired microstructures for the materials in the first and/or second segments. Because desired microstructures for the alloys involved in the described embodiments often include controlled formation and distribution of phases, such as by precipitation strengthening processes, the heat treatment step used in such embodiments is a multiple-stage heat treatment, involving holding the intermediate article at different temperatures during different stages, and in some cases involving cooling procedures between stages where the article is cooled at controlled rates to achieve desired phase size, morphology, and/or distribution. The physical metallurgy of titanium aluminide alloys and nickel-based superalloys is well-developed and the characteristics of desirable microstructures in these alloy systems, and various heat treatments used to obtain them, will be apparent to those skilled in the art. For example, a desirable microstructure for a titanium aluminide-type alloy in some embodiments has a gamma phase titanium aluminide matrix, and in some embodiments one or more other phases, such as, but not limited to, alpha phase titanium (hexagonal close-packed structured titanium), alpha-two phase (nominal composition Ti₃Al), and/or beta phase (body-centered cubic titanium), is dispersed within the matrix in a morphology and volume fraction effective to control the grain size of the material; in alternative embodiments, a lamellar microstructure that includes, for example, gamma and alpha-2 phases is desirable. In another example, a desirable microstructure for a nickel-based superalloy in some embodiments is an austenitic-type nickel-bearing matrix with a dispersion of gamma prime precipitates of a size distribution and volume fraction effective to hinder dislocation motion and control the grain size.

Complex microstructures of the type described above may be achieved by a series of stages performed within the overall step of heat treatment, often involving heating to a first temperature, such as the temperature described above, to further diffuse the barrier material into the first and second segments, then changing to a lower, second temperature to, for instance, form a desired phase in a lamellar structure or as a dispersed precipitate. The heat treatment may involve subsequent heating stages at progressively lower temperatures to stabilize the microstructure or form other phases. Actual temperatures and times selected will depend in part on the type of alloys being heat treated, the composition of the phase(s) to be formed, and the desired morphology and size of the phase(s). An illustrative heat treatment regimen includes a first heat treatment stage at 1050-1080 degrees Celsius for 4-8 hours, followed by furnace cool to a second heat treatment at 850-1000 degrees Celsius for 6-16 hours, followed by a furnace cool to ambient temperature.

The following illustrative embodiment is provided to demonstrate a particular embodiment of the method. The method includes interposing a barrier material comprising at least about 30 weight percent of niobium, tantalum, or combinations of either or both of these between a first segment and a second segment to form a segment assembly, wherein the first segment comprises a gamma titanium aluminide material and the second segment comprises a nickel-based superalloy; bonding the segment assembly in the solid state at a temperature in the range from about 900 degrees Celsius to about 1300 degrees Celsius, pressure in the range from about 4 megapascals to about 7 megapascals, and time effective to produce a metallurgical joint between the first and second segments, thereby forming an intermediate article; and heat treating the intermediate article in a multiple-stage heat treatment to form a bonded article.

The heat treatment step transforms the intermediate article into a bonded article. Referring to FIG. 1, the article 100 formed by the method described above is characterized by a first portion 110 bonded to a second portion 120 via a transition zone 130. First portion 110 corresponds to the first segment described above and thus comprises the titanium aluminide material as noted previously. Second portion 120 corresponds to the second segment described above and thus comprises the nickel alloy as noted previously. Transition zone 130 corresponds to the region affected by the interdiffusion among the material of the first segment, the material of the second segment, and the barrier material. The actual size and composition of the transition zone will depend on the extent to which the heat treatment step noted previously promotes diffusion of the barrier material constituents to diffuse into the first and second portions 110, 120. Generally, except for embodiments in which the heat treatment step is carried out to such an extent that the barrier material is allowed to completely diffuse away, transition zone 130 is characterized by a concentration of a barrier material constituent element that is higher than a concentration of that element in first and second portions 110, 120. For example, where niobium is used as a primary constituent element of the barrier material, transition zone 130 will typically exhibit a higher concentration of niobium than will be observed in either the titanium aluminide alloy of first portion 110 or the nickel alloy of second portion 120. Where the primary constituent element has been completely diffused away from transition zone 130 into portions 110, 120, transition zone is characterized 130 by a concentration gradient in key elements of the alloys making up respective portions 110, 120. For example, titanium will have a relatively high concentration in the titanium aluminide of first portion 110, a relatively lower concentration in the nickel alloy of second portion 120, and a gradient across transition zone in which the average titanium concentration is intermediate to the high concentration and the lower concentration.

The method described above, when executed in accordance with some embodiments of the present invention, further provides a transition zone 130 that is substantially free of low-melting-point material, such as material comprising nickel, titanium, and aluminum. A phase is considered “low-melting-point” here and throughout this description when its melting point is within +/−100 degrees Celsius of the desired operating temperature of article 100; in some embodiments, a low-melting-point phase has a melting point below 1000 degrees Celsius. Having material with low melting point is undesirable because this material can serve as a site for incipient melting during processing or service, can sequester constituent elements such as titanium and aluminum that are more advantageously used in matrix or strengthening phases, and, depending on their concentration and morphology, can serve as nucleation sites and/or propagation paths for cracks. In particular, the formation of a substantially continuous region of a comparatively brittle phase is not acceptable for high temperature/high stress applications, because of their tendency to allow cracks to initiate and quickly propagate through the material. Transition zone 130 is substantially free of such regions in embodiments of the present invention.

Article 100 formed by the techniques described above can be used in high temperature components, with portions 110, 120 disposed where the attributes of their respective materials may be applied to best advantage, or where their disadvantages may be most efficiently mitigated. Examples of such components include, but are not limited to, components of gas turbine assemblies such as a turbine airfoil component (including turbine blades (also sometimes referred to as “buckets”) and vanes (also sometimes referred to as “nozzles”), or a bladed disk (“blisk”)). In one example, a turbine airfoil component used in, for instance, an industrial gas turbine, is produced using the aforementioned techniques such that it comprises a titanium aluminide material in airfoil outer sections (that is, portions of the airfoil disposed a further radial distance from the center of the rotor than the inner sections noted below) such as the airfoil tip and tip shroud, with nickel-based superalloy disposed, for instance, at the inner sections of the airfoil, such as those proximate to where the airfoil is attached to the rotor (dovetail, platform, root sections, etc.). In this example, the hybrid configuration of the diffusion bonded component makes use of the superior high temperature strength and fatigue performance of the superalloy advantageously applied in the inner portions of the airfoil, and the lower density and greater creep performance of the titanium aluminide in the outer portions of the airfoil. In accordance with this illustrative description, article 100 in FIG. 1 corresponds to the airfoil, with first portion 110 corresponding to the outer portion(s), such as the tip and/or tip shroud, that includes the titanium aluminide material, while second portion 120 corresponds to inner portion(s) comprising the nickel alloy, such as the dovetail, platform, and/or root sections. One or more transition zone 130 exists in the airfoil 100 wherever diffusion bonding occurs to join a titanium aluminide-bearing portion 110 to a nickel-alloy-bearing portion 120.

### EXAMPLES

The following examples are presented to further illustrate non-limiting embodiments of the present invention.

A first cylindrical titanium aluminide alloy segment of nominal composition 42.25 weight percent aluminum, 8 weight percent niobium, 1.5 weight percent boron, balance titanium, was cut from an ingot and heat treated at 1340 degrees Celsius for 10 hours, followed by 10 hours at 1000 degrees Celsius, to achieve a substantially fully lamellar microstructure. A second cylindrical segment of nickel alloy GTD444 was provided. Both segments were ground to a final surface finish using 1200 grit paper. A barrier material was provided by depositing 1-8 micrometers of niobium onto the GTD-444 segment by magnetron sputtering.

The segments were place into contact with each other so that the niobium-coated surface of the GTD444 was a faying surface of the diffusion bonding joint; that is, the niobium barrier material was interposed between the titanium aluminide alloy of the first segment and the GTD444 material of the second segment. This assembly of segments was then placed in a hot press and bonded under the following conditions: temperature—1020 degrees Celsius; pressure—5 megapascals; vacuum: 10⁻⁶ to 10⁻⁷ torr; time—180 minutes. The bonded assembly was then heat treated for four hours at 1080 degrees Celsius, followed by a furnace cool to 900 degrees Celsius and held for a further 10 hours, followed by a furnace cool to ambient.

After processing, the final article was cross-sectioned and the joint was metallographically examined No voids or cracks were observed at the bond-line. No continuous brittle intermetallic phases were observed in the joint and its adjoining regions. Finally, no evidence of eutectic formation, such as cracking or incipient melting/resolidification, was observed.

In contrast, specimens bonded in the same manner but without the niobium barrier material were observed to have extensive cracking along the bond-line close to the nickel alloy segment, and this cracking was attributed to the formation of a eutectic phase (containing nickel, aluminum, titanium, and chromium) in a substantially continuous region along the bond.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method comprising:
interposing a barrier material between a first segment and a second segment to form a segment assembly, wherein the first segment comprises a titanium aluminide material, the second segment comprises a nickel alloy, and the barrier material comprises a primary constituent element present in the barrier material at a concentration of at least about 30 weight percent of the barrier material; wherein the primary constituent element is a transition metal element of Group 1B, Group 4B (excluding titanium and zirconium), Group 5B, Group 6B, Group 7B, or Group 8B (excluding nickel);
bonding the segment assembly in the solid state at a combination of temperature, pressure, and time effective to produce a metallurgical joint between the first and second segments, thereby forming an intermediate article; and
heat treating the intermediate article to form a bonded article.

2. The method of claim 1, wherein the primary constituent element comprises niobium or tantalum.

3. The method of claim 1, wherein interposing comprises depositing a layer comprising the barrier material on one or both of the segments.

4. The method of claim 1, wherein the titanium aluminide material comprises gamma titanium aluminide.

5. The method of claim 1, wherein the temperature of the bonding step is in the range from about 900 degrees Celsius to about 1100 degrees Celsius.

6. The method of claim 1, wherein the pressure of the bonding step is in the range from about 4 megapascals to about 7 megapascals.

7. The method of claim 1, wherein the bonding step is performed in a substantially inert environment.

8. The method of claim 1, wherein heat treating the intermediate article comprises heating the intermediate article to a temperature in a range from about 900 degrees Celsius to about 1300 degrees Celsius.

9. The method of claim 1, wherein heat treating comprises a multiple-stage heat treatment.

10. The method of claim 1, wherein the nickel alloy is a nickel-based superalloy.

11. The method of claim 1, wherein the bonded article comprises a component for a gas turbine assembly.

12. The method of claim 11, wherein the component comprises an airfoil.

13. A method comprising:
interposing a barrier material comprising at least about 30 weight percent of niobium, tantalum, or combinations of either or both of these between a first segment and a second segment to form a segment assembly, wherein the first segment comprises a gamma titanium aluminide material and the second segment comprises a nickel-based superalloy;
bonding the segment assembly in the solid state at a temperature in the range from about 900 degrees Celsius to about 1300 degrees Celsius, pressure in the range from about 4 megapascals to about 7 megapascals, and time effective to produce a metallurgical joint between the first and second segments, thereby forming an intermediate article; and
heat treating the intermediate article in a multiple-stage heat treatment to form a bonded article.

14. An article comprising:
A first portion bonded to a second portion via transition zone, wherein the first portion comprises a titanium aluminide material, the second portion comprises a nickel alloy, wherein the barrier material comprises a primary constituent element present at a concentration of at least about 30 weight percent of the barrier material; wherein the primary constituent element is a transition metal element of Group 1B, Group 4B (excluding titanium and zirconium), Group 5B, Group 6B, Group 7B, or Group 8B (excluding nickel); and wherein and the transition zone comprises a concentration of the primary constituent element that is higher than a concentration of the primary constituent element in the first portion and the second portion.

15. The article of claim 14, wherein the primary constituent element comprises niobium, tantalum, or combinations of either or both of these.

16. The article of claim 14, wherein the transition zone is substantially free of material having a melting point below about 1000 degrees Celsius.

17. The article of claim 14, wherein the nickel alloy is a nickel-based superalloy.

18. The article of claim 14, wherein the titanium aluminide material comprises gamma titanium aluminide.

19. The article of claim 14, wherein the article comprises an airfoil component for a gas turbine assembly.
